(19) United States
(12) Patent Application Publication
(10) Pub. No.: US 2013/0074343 A1
(43) Pub. Date: Mar. 28, 2013

(54) METHOD OF MANUFACTURING A PANEL ASSEMBLY

(71) Applicants: David C. Newkirk, Lawrenceburg, IN (US); Earl L. Rowland, Batesville, IN (US); Joseph H. Abel, New Palestine, IN (US); John E. Billman, Osgood, IN (US); Timothy G. Schneider, Sunman, IN (US); Matthew T. Rosemeyer, Brookville, IN (US); Brian J. Hoffman, Lawrenceburg, IN (US)

(72) Inventors: David C. Newkirk, Lawrenceburg, IN (US); Earl L. Rowland, Batesville, IN (US); Joseph H. Abel, New Palestine, IN (US); John E. Billman, Osgood, IN (US); Timothy G. Schneider, Sunman, IN (US); Matthew T. Rosemeyer, Brookville, IN (US); Brian J. Hoffman, Lawrenceburg, IN (US)

(21) Appl. No.: 13/245,005

(22) Filed: Sep. 26, 2011

(51) Int. Cl. B23P 17/00

(52) U.S. Cl. 29/897.32

(57) ABSTRACT

A method of manufacturing a panel assembly comprises the steps of: forming a base structure including a first layer and mounting members; bending the mounting members to define a mounting surface; forming a second layer; and coupling the second layer to the first layer.

### BACKGROUND OF THE DISCLOSURE

This disclosure relates generally to panel assemblies. More particularly, but not exclusively, one illustrative embodiment relates to a method of manufacturing a panel assembly for use with a module system. While various methods have been developed, there is still room for improvement. Thus a need persists for further contributions in this area of technology.

### SUMMARY OF THE DISCLOSURE

In one illustrative embodiment a method of manufacturing a panel comprises the steps of: forming a base structure including a first layer and mounting members; bending the mounting members to define a mounting surface; forming a second layer; and coupling the second layer to the first layer.

In another illustrative embodiment, a method of manufacturing a panel comprises the steps of: forming a first layer; forming a plurality of mounting members; forming a second layer; coupling the second layer to the first layer; bending the mounting members to define a mounting surface; and coupling the first layer and second layer to the mounting members.

In another illustrative embodiment, a method of manufacturing a panel comprises the steps of: forming a base structure including a panel portion and mounting members extending from the panel portion; bending the mounting members to define side surfaces and mounting surfaces; forming a second layer; and coupling the second layer to the panel portion.

In yet another illustrative embodiment, a method of manufacturing a panel comprises the steps of: forming a first layer with at least one post hole extending there through; forming a second layer; coupling the second layer to a first surface of the first layer such that the second layer overlaps the first layer; and coupling at least one post to the first layer such that a portion of the post is positioned in the at least one post hole and a portion of the post extends from a second surface of the first layer.

Additional features alone or in combination with any other feature(s), including those listed above and those listed in the claims and those described in detail below, can comprise patentable subject matter. Others will become apparent to those skilled in the art upon consideration of the following detailed description of illustrative embodiments exemplifying the best mode of carrying out the invention as presently perceived.

### BRIEF DESCRIPTION OF THE DRAWINGS

Referring now to the illustrative examples in the drawings, wherein like numerals represent the same or similar elements throughout:

FIG. 1 is a front view of a panel assembly according to an illustrative embodiment of the disclosure;

FIG. 2 is an exploded view of the panel assembly of FIG. 1 showing the laminate panel and trim, and the base structure;

FIG. 3 is a front view of the base structure of FIGS. 1 and 2 prior to the mounting members being bent;

FIG. 4 is a flow chart of a process for manufacturing the panel assembly of FIG. 1

FIG. 5 is an exploded view of a panel assembly according to another illustrative embodiment of the disclosure showing the base panel including a mounting frame and a base panel;

FIG. 6 is a front view of panel assembly of FIG. 5 showing the laminate panel, base panel, and frame bracket coupled to one another; and

FIG. 7 is a flow chart of a process for manufacturing the panel assembly of FIG. 5.

### DETAILED DESCRIPTION OF THE DRAWINGS

While the present disclosure can take many different forms, for the purpose of promoting an understanding of the principles of the disclosure, reference will now be made to the embodiments illustrated in the drawings, and specific language will be used to describe the same. No limitation of the scope of the disclosure is thereby intended. Various alterations, further modifications of the described embodiments, and any further applications of the principles of the disclosure, as described herein, are contemplated.

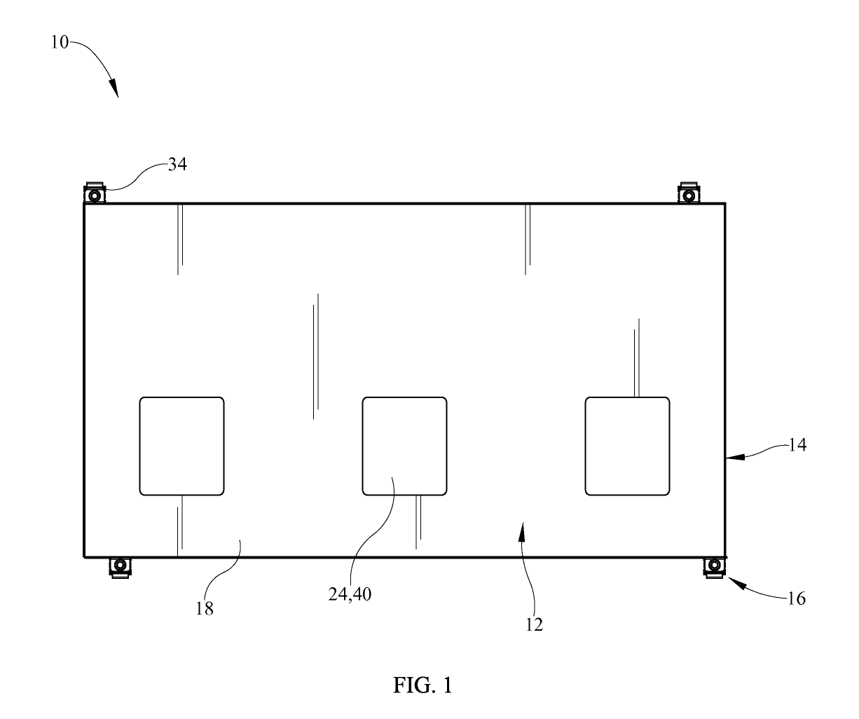

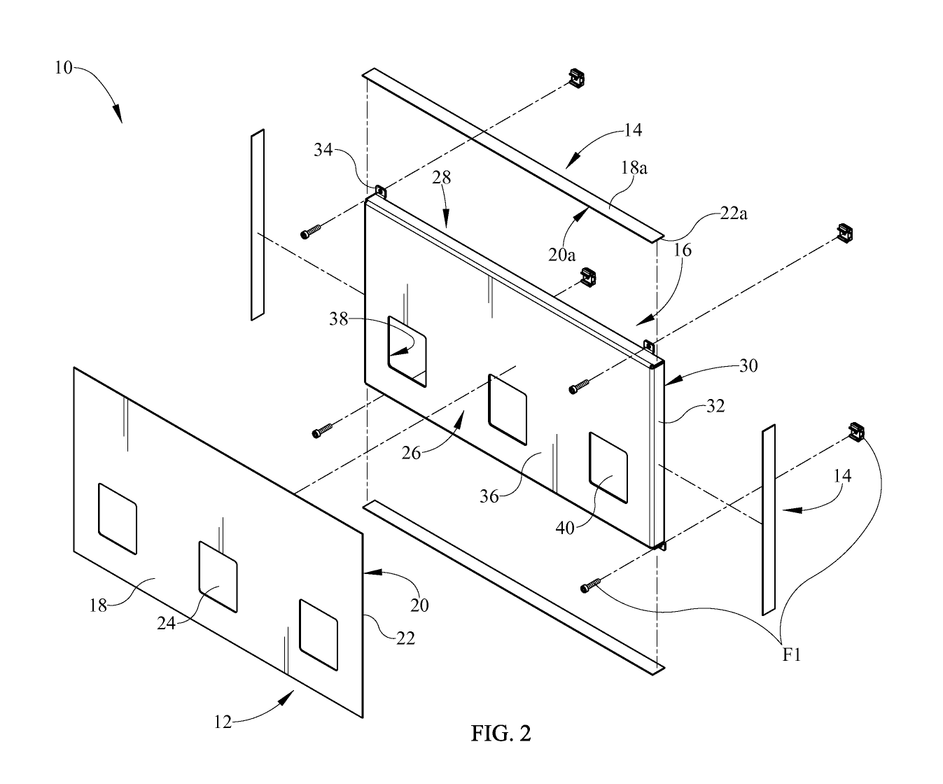

A panel assembly 10 according to one illustrative embodiment of the current disclosure is shown in FIGS. 1-4. The panel assembly 10 is a service panel assembly for a medical headwall system (not shown), such as, for example, the Basis™ headwall system or Elements™ headwall system sold by Hill-Rom®. In some contemplated embodiments, the panel assembly 10 can be used with any modular panel system. The panel assembly 10 comprises a laminate panel 12, laminate trim 14, and a base structure 16 as shown in FIG. 1-3. In one illustrative embodiment, the laminate panel 12 and laminate trim 14 are generally planar and are composed of a phenolic backing with a melamine top layer that is used for decorative purposes, such as, for example, colored using one or more colors, mimicking wood grain, or other stylistic arrangements. In some contemplated embodiments, the laminate panel 12 and/or laminate trim 14 can be composed of other materials, such as, vinyl, polyester, PVC, metal, paper, wood veneers, printed graphics, or any other suitable material or combination thereof. In some contemplated embodiments, the laminate trim 14 can be a single piece designed that can be wrapped around the sides of the base panel 16. Commercially available examples of laminate panels are sold or distributed by Formica, Nevamar, Pioneer Plastics, and Wilsonart, among others.

The laminate panel 12 includes a first surface 18 or front surface 18, a second surface 20 or bonding surface 20, a side surface 22 or third surface 22 extending between the front surface 18 and the bonding surface 20, and cut-outs 24. The cut-outs allow service outlets (not shown), such as, for example, a gas outlet, an electrical outlet, or other service outlet, to pass through when the panel assembly 10 is coupled to a modular panel system support (not shown). In some contemplated embodiments, the modular panel system support includes a wall stud and/or frame. The laminate trim 14 includes a first surface 18a or front surface 18a, a second surface 20a or bonding surface 20a, and a third surface 22a or side surface 22a extending between the front surface 18a and the bonding surface 20a.

The base structure 16 is configured to be coupled to the laminate panel 12 and laminate trim 14, and to couple the assembly to the modular panel system support with a plurality of fasteners F1. In one illustrative embodiment, the base structure 16 is composed of galvanized steel and the fasteners are screws. In other contemplated embodiments, the base structure 16 can be composed of other suitable materials, such as, aluminum, plastic, or carbon fiber, and the fasteners can be snaps or can include slots in the wall stud/frame that can receive a portion of the base structure 16. The base structure 16 includes a first layer 26 or panel portion 26 and mounting members 28. The mounting members 28 extend from the sides of the panel portion 26 and are configured to be bent to form a mounting frame 30 with side surfaces 32 and mounting surfaces 34. The mounting surfaces 34 are configured to be secured to the wall stud/frame of the modular panel system with fasteners F1 and the side surfaces 32 are configured to abut panel assemblies and/or wall structure adjacent to the panel assembly 10. The panel portion 26 includes a first surface 36 or bonding surface 36, a second surface 38 or back surface 38, and cut-outs 40. The cut-outs 40 allow service outlets to pass through when the panel assembly 10 is coupled to the modular panel system support. The cut-outs 40 are configured to be substantially aligned with the cut-outs 24 in the laminate panel 12 when the laminate panel 18 is coupled to the base structure 16.

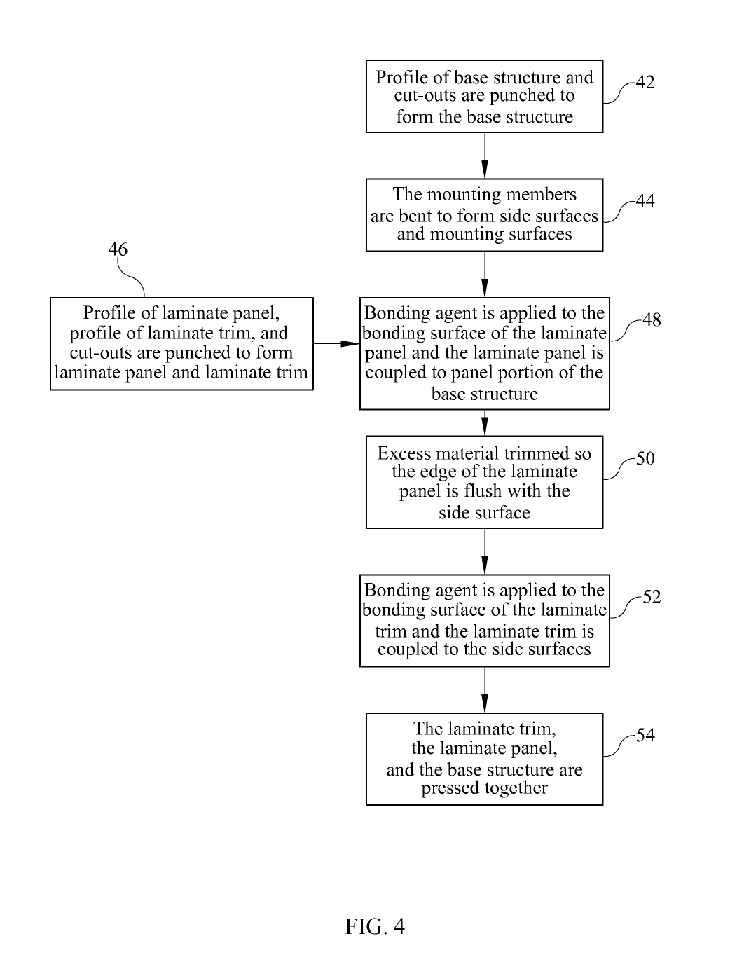

FIG. 4 shows a process for manufacturing the panel assembly 10 according to one illustrative embodiment. The process includes steps 42, 44, 46, 48, 50 and 52, and step 46 may be completed simultaneously with at least one of steps 42 and 44. In step 42, a sheet of galvanized steel is placed in a die press and the profile of the base structure 16 (the panel portion 26 and the mounting members 28) and the appropriate cut-outs 24 are punched to form the base structure 16.

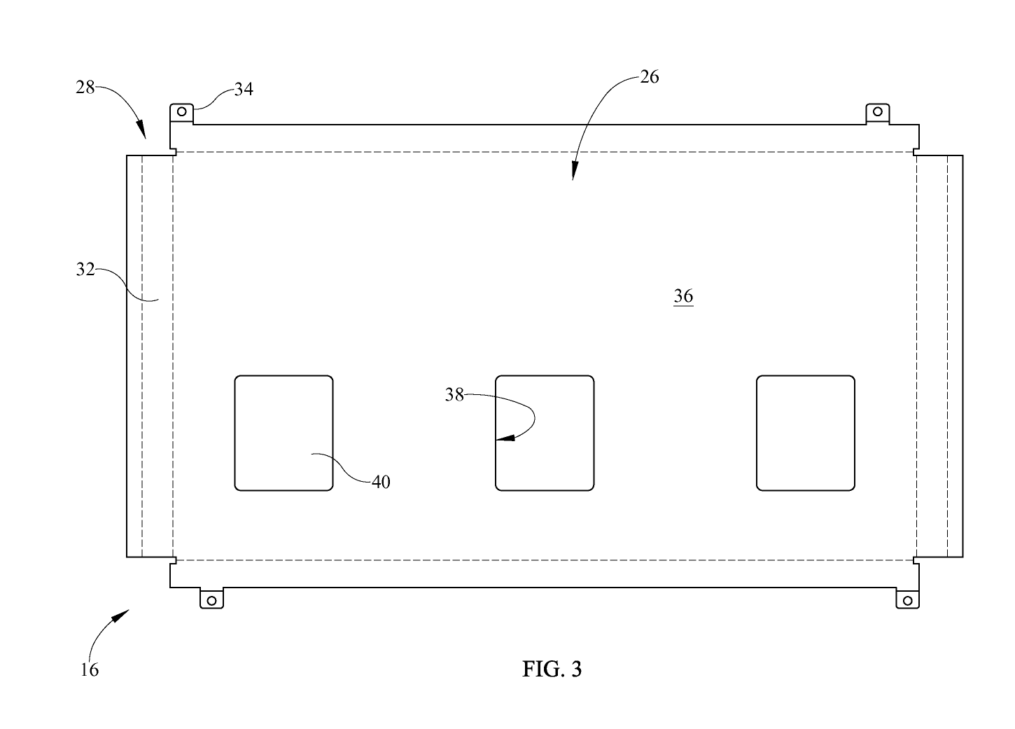

In step 44, the base structure 16 is placed on a brake press and the mounting members 28 are bent to form the side surfaces 32 and mounting surfaces 34 of the mounting frame 30. In some contemplated embodiments, the mounting members 28 are not bent and remain substantially planar with the panel portion 26 as shown in FIG. 3, which allows the mounting members 28 to be received in slots in the modular panel system supports or coupled to the modular panel system supports using fasteners F1.

In step 46, a sheet of laminate material is placed in a die press and the profile of the laminate panel 12, the profile of the laminate trim 14, and the appropriate cut-outs 24 are punched to form the laminate panel 12 and the laminate trim 14. In one illustrative embodiment, the laminate panel 12 and/or the laminate trim 14 can be formed so that the perimeter of the laminate panel 12 and laminate trim 14 is slightly larger than the panel portion 26 of the base structure 16 and/or side mounting surfaces 36 of the mounting frame 30.

In step 48, a bonding agent, such as, adhesive, is applied to the bonding surface 20 of the laminate panel 12 and the laminate panel 12 is positioned on the bonding surface 36 of the panel portion 26 with the cut-outs 18 and 24 of each being substantially aligned with one another. In some contemplated embodiments, the laminate panel 12 can be coupled to the panel portion 26 and the cut-outs 18 and 24 punched before the mounting members 28 are bent.

In step 50, any excess material of the laminate panel 12 is trimmed so that the perimeter edges of the laminate panel 12 are substantially flush with the side surfaces 32 of the mounting frame 30.

In step 52, a bonding agent, such as, adhesive, is applied to the bonding surface 20a of the laminate trim 14 and the laminate trim 14 is positioned on the side surfaces 32 of the mounting frame 30 with a side surface 22a flush with the front surface 18 of the laminate panel 12, a side surface 22a substantially flush with the mounting surfaces 34, and the remaining side surfaces substantially flush with one of the bonding surface 20a and the front surface 18a of adjacent laminate trim 14. In one illustrative embodiment, the panel assembly 10 includes four pieces of laminate trim 14 with two pieces the length of the side surfaces 32 and two pieces the length of the side surfaces 32 plus the thickness of the two shorter laminate trim 14 pieces so that the laminate trim 14 forms a continuous perimeter edge of the panel assembly 10. In other contemplated embodiments, the panel assembly 10 includes four pieces of laminate trim 14 of the same length and the laminate trim pieces are staggered when mounted to the side surfaces 32 such that one side surface 22a is substantially flush with an end of the side surface 32 and an opposite side surface 22a overhangs an opposite end of the side surface 32. In other contemplated embodiments, the laminate trim 14 is a single piece, such as, for example, a roll of adhesive backed trim, that wraps around the side surfaces 32.

In step 54, the panel assembly 10 is placed in a press and pressure is applied to the laminate panel 12, laminate trim 14, and base structure 16 to facilitate bonding of the materials.

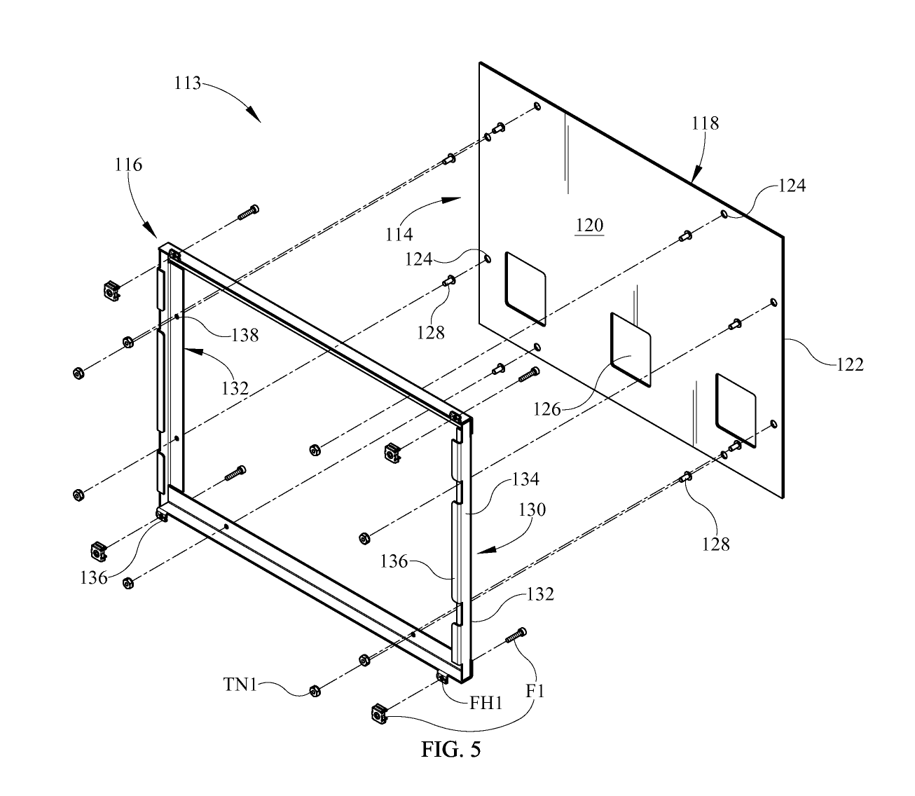

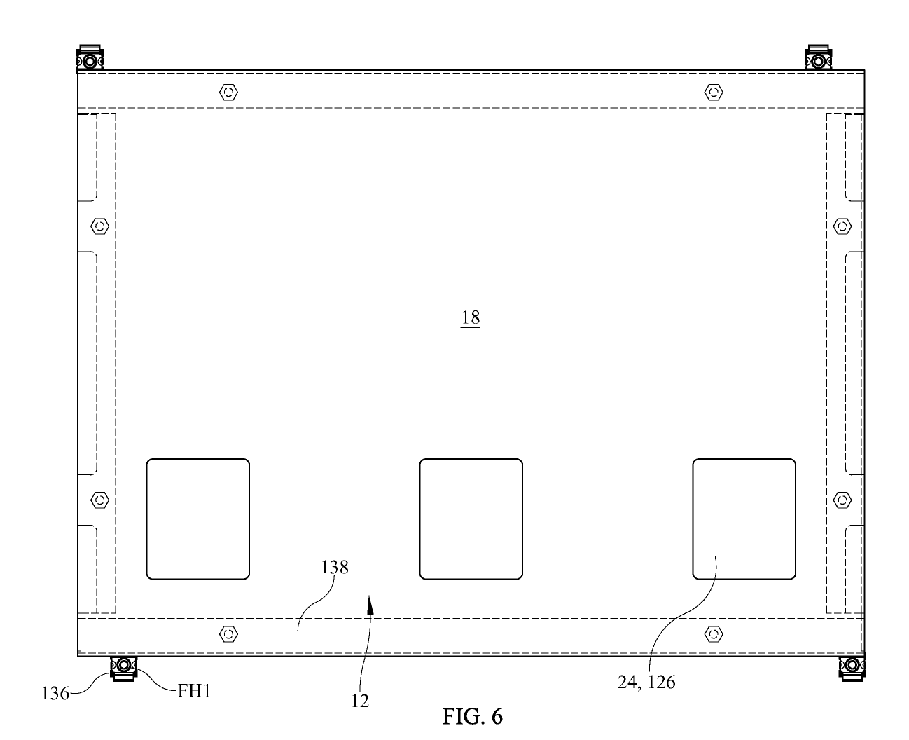

A panel assembly 110 according to another illustrative embodiment of the current disclosure is shown in FIGS. 5-7. The panel assembly 110 comprises a laminate panel 12 and a base structure 113 including a base panel 114 and mounting members 130 that are coupled together to form a mounting frame 116. In some contemplated embodiments, the base structure 113 does not include a mounting frame 116 and the base panel 114 is coupled to the modular panel system support. The base panel 114 includes a first surface 118 or bonding surface 118, a second surface 120 or back surface 120, a third surface 122 or side surface 122 extending between the first surface 118 and the surface 120, post holes 124, and cut-outs 126. In one illustrative embodiment, the base panel 114 is composed of galvanized steel. In other contemplated embodiments, the base panel 114 can be composed of other suitable materials, such as, aluminum, plastic, or carbon fiber. The post holes 124 are configured to receive and retain threaded posts 128 that are configured to couple the base panel 114 to the mounting frame 116. In some contemplated embodiments, the threaded posts 128 are configured to extend from the back surface 120 and configured to be substantially flush with the bonding surface 118. In some contemplated embodiments, the threaded posts 128 can be retained in the post holes 124 a number of ways, including, but not limited to, being pressed into the post holes 124, positioned in the post holes 124 and welded in place, and threaded into the post holes 124. Also, in some contemplated embodiments, the threaded posts 128 are configured to couple the base panel 114 to the modular panel system supports. The cut-outs 126 allow service outlets to pass through when the panel assembly 110 is coupled to a modular panel system support. The cut-outs 126 are configured to be substantially aligned with the cut-outs 126 in the laminate panel 112.

The mounting frame 116 comprises a plurality of mounting members 130 and is configured to couple the base panel 114 and laminate panel 112 to a wall stud/frame of a modular panel system. The mounting members 130 are generally cut from a flat sheet of metal, such as, galvanized steel, and are subsequently bent to form a front mounting surface 132, a side surface 134, and a back mounting surface 136. The front mounting surface 132 includes post holes 138 there through configured to receive the threaded posts 128. The side surface 134 is substantially flush with the perimeter edge of the laminate panel 112 and the base panel 114 when the panel assembly 110 is coupled together. The back mounting surface 136 is configured to be coupled to a wall stud/frame of a modular panel system via fasteners F1 to mount the panel assembly 110. In some contemplated embodiments, the back mounting surface 136 can include fastener holes FH1 that the fasteners Fl pass through to couple the mounting frame 116 to the wall stud/frame.

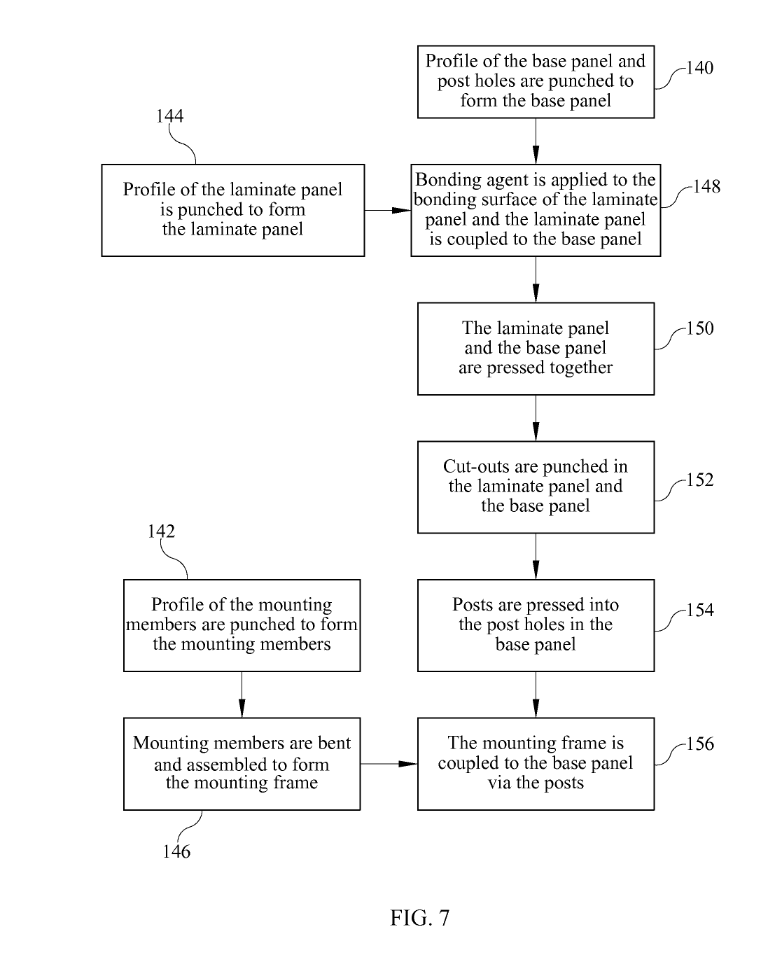

FIG. 7 shows a process for manufacturing the panel assembly 110 according to one illustrative embodiment. The process includes steps 140, 142, 144, 146, 148, 150, 152, and 154. In some contemplated embodiments, steps 140 and 144 may be completed simultaneously with one of steps 142 and 146. In step 140, a sheet of galvanized steel is placed in a die press and the profile of the base panel 114 and the post holes 124 are punched to form the base panel 114.

In step 142, a sheet of galvanized steel is placed in a die press and the profiles of the mounting members 130 and the post holes 138 are punched to form the mounting members 130. In some contemplated embodiments, the mounting members 130 are punched from the same sheet of steel that the base panel 114 is. In some contemplated embodiments, the mounting members 130 and base panel 114 are formed simultaneously. In some contemplated embodiments, fastener holes FH1 are also be punched in the mounting members 130. In some contemplated embodiments, the base structure 113 does not include mounting members 130.

In step 144, a sheet of laminate material is placed in a die press and the profile of the laminate panel 12 is punched to form the laminate panel 12. In one illustrative embodiment, the laminate panel 12 is formed so that the perimeter of the laminate panel 12 is substantially flush with the perimeter of the base panel 114.

In step 146, the mounting members 130 are placed on a brake press and are bent to form the front mounting surface 132, side surfaces 134 and back mounting surfaces 136 of the mounting frame 116. The mounting members 130 are coupled to one another to form the mounting frame 116.

In step 148, a bonding agent, such as, adhesive, is applied to the bonding surface 20 of the laminate panel 12 and the laminate panel 12 is positioned on the bonding surface 118 of the base panel 114 such that the perimeter edges of the laminate panel 12 and the base panel 114 are substantially flush.

In step 150, the laminate panel 112 and the base panel 114 are pressed together, such as, for example, with a manual roll press, to facilitate bonding of the laminate panel 112 and base panel 114.

In step 152, the laminate panel 112 and base panel 114 are placed in a press and the cut-outs 126 and 24 are punched.

In step 154, the threaded posts 128 are pressed into the post holes 124 and extend from the back surface 120 of the base panel 114.

In step 156, the laminate panel 12 and base panel 114 are coupled to the mounting frame 116 via the threaded posts 128. In some contemplated embodiments, the threaded posts 128 are engaged by a threaded nut TN1 to couple the laminate panel 12 and base panel 114 to the mounting frame 116.

Many other embodiments of the present disclosure are also envisioned. For example, a method of manufacturing a panel comprises the steps of: forming a base structure including a first layer and mounting members; bending the mounting members to define a mounting surface; forming a second layer; and coupling the second layer to the first layer.

In another example, a method of manufacturing a panel comprises the steps of: forming a first layer; forming a plurality of mounting members; forming a second layer; coupling the second layer to the first layer; bending the mounting members to define a mounting surface; and coupling the first layer and second layer to the mounting members.

In another example, a method of manufacturing a panel comprises the steps of: forming a base structure including a panel portion and mounting members extending from the panel portion; bending the mounting members to define side surfaces and mounting surfaces; forming a second layer; and coupling the second layer to the panel portion.

In another example, a method of manufacturing a panel comprises the steps of: forming a first layer with at least one post hole extending there through; forming a second layer; coupling the second layer to a first surface of the first layer such that the second layer overlaps the first layer; and coupling at least one post to the first layer such that a portion of the post is positioned in the at least one post hole and a portion of the post extends from a second surface of the first layer.

Any theory, mechanism of operation, proof, or finding stated herein is meant to further enhance understanding of principles of the present disclosure and is not intended to make the present disclosure in any way dependent upon such theory, mechanism of operation, illustrative embodiment, proof, or finding. It should be understood that while the use of the word preferable, preferably or preferred in the description above indicates that the feature so described can be more desirable, it nonetheless can not be necessary and embodiments lacking the same can be contemplated as within the scope of the disclosure, that scope being defined by the claims that follow.

In reading the claims it is intended that when words such as “a,” “an,” “at least one,” “at least a portion” are used there is no intention to limit the claim to only one item unless specifically stated to the contrary in the claim. When the language “at least a portion” and/or “a portion” is used the item can include a portion and/or the entire item unless specifically stated to the contrary.

It should be understood that only selected embodiments have been shown and described and that all possible alternatives, modifications, aspects, combinations, principles, variations, and equivalents that come within the spirit of the disclosure as defined herein or by any of the following claims are desired to be protected. While embodiments of the disclosure have been illustrated and described in detail in the drawings and foregoing description, the same are to be considered as illustrative and not intended to be exhaustive or to limit the disclosure to the precise forms disclosed. Additional alternatives, modifications and variations can be apparent to those skilled in the art. Also, while multiple inventive aspects and principles can have been presented, they need not be utilized in combination, and various combinations of inventive aspects and principles are possible in light of the various embodiments provided above.

What is claimed is:

1. A method of manufacturing a panel assembly, comprising the steps of:
forming a base structure including a first layer and mounting members;
bending the mounting members to define a mounting surface;
forming a second layer; and
coupling the second layer to the first layer.

2. The method of claim 1, wherein the step of forming the base structure includes forming the first layer separate from the mounting members.

3. The method of claim 1, wherein the step of forming the base structure includes forming the first layer with the mounting members extending from the first member.

4. The method of claim 1, wherein the step of forming the base structure includes forming at least one service outlet hole in the first layer.

5. The method of claim 1, wherein the step of forming the second layer includes forming at least one service outlet hole in the second layer.

6. The method of claim 1, wherein the step of coupling the second layer to the first layer includes substantially aligning a service outlet hole formed in the first layer with a service outlet hole formed in the second layer.

7. The method of claim 1 further comprising the steps of:
forming side trim members; and
coupling the side trim members to a non-mounting surface of the mounting members.

8. The method of claim 8, wherein the side trim members include a laminate material.

9. The method of claim 1, wherein the first layer is coupled to the second layer and a service outlet opening is formed through the first layer and the second layer before the first layer and second layer are coupled to the mounting members.

10. The method of claim 1, wherein the step of forming the base structure includes forming post holes in the first layer.

11. The method of claim 10, wherein posts configured to couple the first layer to the mounting members are retained in the post holes.

12. The method of claim 1, wherein the mounting members are coupled to one another.

13. The method of claim 1, wherein the second layer includes a laminate material.

14. The method of claim 1, wherein the first layer is coupled to the second layer with an adhesive.

15. A method of manufacturing a panel, comprising the steps of:
forming a first layer;
forming a plurality of mounting members;
forming a second layer;
coupling the second layer to the first layer;
bending the mounting members to define a mounting surface; and
coupling the first layer and second layer to the mounting members.

16. The method of claim 15, further comprising the step of forming at least one supply outlet opening in the first layer and the second layer after the second layer is bonded to the first layer.

17. The method of claim 15, wherein the step of forming the first layer includes forming a plurality of post openings in the first layer.

18. The method of claim 17, wherein a plurality of posts are retained in the post openings and are configured to couple the first layer and the second layer to the plurality of mounting members.

19. A method of manufacturing a panel, comprising the steps of:
forming a base structure including a panel portion and mounting members extending from the panel portion;
bending the mounting members to define side surfaces and mounting surfaces;
forming a second layer; and
coupling the second layer to the panel portion.

20. The method of claim 19, wherein the step of forming the base structure includes forming at least one supply outlet opening in the panel portion.

21. The method of claim 19, wherein the step of forming the second layer includes forming at least one supply outlet opening in the second layer.

22. The method of claim 19, wherein the second layer includes a laminate material.

23. The method of claim 19 further comprising the steps of:
forming a side layer; and
coupling the side layer to at least one of the side surfaces.

24. A method of manufacturing a panel, comprising the steps of:
forming a first layer with at least one post hole extending there through;
forming a second layer;
coupling the second layer to a first surface of the first layer such that the second layer overlaps the first layer; and
coupling at least one post to the first layer such that a portion of the post is positioned in the at least one post hole and a portion of the post extends from a second surface of the first layer. .
